(19) United States
(12) Patent Application Publication
(10) Pub. No.: US 2026/0202014 A1
(43) Pub. Date: Jul. 16, 2026

(54) VESSEL FOR THE STORAGE OF GAS

(71) Applicant: SOLVAY SPECIALTY POLYMERS USA, LLC, Alpharetta, GA (US)

(72) Inventors: Florence Clement, Saint-Fons (FR); Yves Vanderveken, Leuven (BE); Stéphane Jeol, Saint-Genis-Laval (FR); Didier Delimoy, Chaumont-Gistoux (BE); Glenn Desio, Marietta, GA (US); Véronique Bossennec, SEREZIN-DURHÔNE (FR); Stefono Montani, Bollate (MI) (IT)

(73) Assignee: SOLVAY SPECIALTY POLYMERS USA, LLC, Alpharetta, GA (US)

(21) Appl. No.: 19/139,303

(22) PCT Filed: Dec. 12, 2023
(86) PCT No.: PCT/EP2023/085329

§ 371 Date: Jun. 13, 2025

Related U.S. Application Data
(60) Provisional application No. 63/387,309, filed on Dec. 14, 2022.

(30) Foreign Application Priority Data
Feb. 27, 2023 (EP) 23158668.6

(51) Int. Cl. F17C 1/16

(52) U.S. Cl. CPC F17C 1/16; F17C 2201/058; F17C 2203/066; F17C 2203/0673; F17C 2221/011; F17C 2221/012; F17C 2221/013; F17C 2221/014; F17C 2221/016; F17C 2221/017; F17C 2221/033; F17C 2221/035; F17C 2270/0168

(57) ABSTRACT

A vessel for the storage and transportation of gasses. The vessel is particularly adapted for the storage and transportation of compressed gasses in vehicles.

### REFERENCE TO RELATED APPLICATIONS

This application claims priority to U.S. provisional application No. 63/387,309—filed Dec. 14, 2022—and to European patent application No. 23158668.6—filed Feb. 27, 2023—, the whole content of each of these applications being incorporated herein by reference for all purposes.

### TECHNICAL FIELD

The invention relates to a vessel for the storage and transport of gasses. The invention further relates to a method for manufacturing the vessel and to a gas stored in the vessel.

### BACKGROUND ART

Pressure vessels characterized by high gas barrier properties have been used for storing various gasses such as oxygen, carbon dioxide, nitrogen, argon, LPG (liquefied petroleum gas), methane, hydrogen, over a long period of time. Pressure vessels comprising a non-structural layer, or liner, surrounded with a structural fiber reinforced composite material for containing the fluid or gas under pressure are known. The liner acts as a barrier between the fluid or gas and the fiber reinforced composite material, thus preventing leaks and/or other degradations of the structure of the fiber reinforced composite material. The use of structural fiber reinforced composite materials comprising a thermoplastic polymer matrix, rather than a thermoset one, is advantageous to facilitate recycling of the pressure vessel.

Pressure vessels comprising a polyamide-based liner and an outer layer which is a composite material that contains a continuous fiber and a polyamide resin impregnated into the continuous fiber are disclosed for instance in EP3225888 A1, EP3390016 A1, and WO21152254 A1.

However the need still exists to develop pressure vessels, in particular pressure vessels for the transport and storage of hydrogen, which combine high performance qualities in terms of impermeability to the stored gas and mechanical properties.

### SUMMARY OF INVENTION

The inventors have found that low permeability to hydrogen and good mechanical properties can be obtained by a vessel comprising a barrier layer or liner combining properties which are a priori antagonistic: high glass transition temperature and high barrier to hydrogen permeation on the one hand and low melting temperature and good ductility at low temperature on the other hand.

A first object of the invention is a vessel comprising at least one barrier layer, [Layer (BL)], which comprises at least one thermoplastic polymer, [thermoplastic polymer (TP)], characterized by:
a glass transition temperature of at least 65° C.;
a melting temperature of at most 320° C.;
an elongation at break at −40° C. of at least 2.5% when measured according to ISO 527-2 using test pieces according to ISO 1BA at a testing speed of 5 mm/min; and
a hydrogen permeation coefficient at 85° C. of at most 500 Ncm³·mm/m²·d·bar.

The vessel conveniently comprises at least one barrier layer, [Layer (BL)] as above defined, and at least one composite layer, [Layer (CL)] in contact with the at least one barrier layer, wherein Layer (CL) comprises continuous reinforcing fibers and a polymer matrix. The polymer matrix may be either thermoplastic or thermoset. Layer (BL) represents the internal layer of the vessel, or liner, while Layer (CL) represents the external layer of the vessel.

The vessel is a pressure vessel, that is a vessel for the storage of a gas under pressure.

A second object of the invention is a compressed gas in the vessel of the first object, wherein Layer (BL) is in contact with the compressed gas. Further objects of the invention are a method for making the vessel as well as the use of the vessel in vehicles or in gas transportation in general.

### DESCRIPTION OF INVENTION

In the present application:
any description, even though described in relation to a specific embodiment, is applicable to and interchangeable with other embodiments of the present disclosure;
where an element or component is said to be included in and/or selected from a list of recited elements or components, it should be understood that in related embodiments explicitly contemplated here, the element or component can also be any one of the individual recited elements or components, or can also be selected from a group consisting of any two or more of the explicitly listed elements or components; any element or component recited in a list of elements or components may be omitted from such list;
any recitation herein of numerical ranges by endpoints includes all numbers subsumed within the recited ranges as well as the endpoints of the range and equivalents;
the indeterminate article “a” in an expression like “a polyamide polymer”, is intended to mean “one or more”, or “at least one” unless indicated otherwise; and
the use of brackets “( )” before and after names of compounds, symbols or numbers, e.g. “Layer (BL)”, has the mere purpose of better distinguishing that name, symbol or number from the rest of the text; thus, said parentheses could also be omitted.

Unless specifically expressed otherwise, the term “alkyl”, as well as derivative terms such as “alkoxy”, “acyl” and “alkylthio”, as used herein, include within their scope straight chain, branched chain and cyclic moieties. Examples of alkyl groups are methyl, ethyl, 1 methylethyl, propyl, 1,1 dimethylethyl, and cyclo-propyl. Unless specifically stated otherwise, each alkyl and aryl group may be unsubstituted or substituted with one or more substituents selected from but not limited to halogen, hydroxy, sulfo, C1-C6 alkoxy, C1-C6 alkylthio, C1-C6 acyl, formyl, cyano, C6-C15 aryloxy or C6-C15 aryl, provided that the substituents are sterically compatible and the rules of chemical bonding and strain energy are satisfied. The term “halogen” or “halo” includes fluorine, chlorine, bromine and iodine, with fluorine being preferred.

The term “aryl” refers to a phenyl, indanyl or naphthyl group. The aryl group may comprise one or more alkyl groups, and are called sometimes in this case “alkylaryl”; for example may be composed of a cyclo-aromatic group and two C1-C6 groups (e.g. methyl or ethyl). The aryl group may also comprise one or more heteroatoms, e.g. N, O or S, and are sometimes called “heteroaryl” groups; these heteroaromatic rings may be fused to other aromatic systems. The aryl or heteroaryl substituents may be unsubstituted or substituted with one or more substituents selected from but not limited to halogen, hydroxy, C1-C6 alkoxy, sulfo, C1-C6 alkylthio, C1-C6 acyl, formyl, cyano, C6-C15 aryloxy or C6-C15 aryl, provided that the substituents are sterically compatible and the rules of chemical bonding and strain energy are satisfied.

### Layer (BL)

A first object of the invention is a vessel comprising at least one barrier layer, [Layer (BL)]. Layer (BL) is formulated to provide the barrier to permeation of gasses.

Layer (BL) does not contain any continuous reinforcing fiber.

Layer (BL) comprises at least one thermoplastic polymer, [thermoplastic polymer (TP)], characterized by:
a glass transition temperature of at least 65° C.;
a melting temperature of at most 320° C.;
an elongation at break at −40° C. of at least 2.5% when measured according to ISO 527-2 using test pieces according to ISO 1BA at a testing speed of 5 mm/min; and
a hydrogen permeation coefficient at 85° C. of at most 500 Ncm³·mm/m²·d·bar.

Glass transition temperature and melting temperature are measured using differential scanning calorimetry (DSC) according to ASTM D3418, on the second heat scan using a heating and cooling rate of 20° C./min.

Thermoplastic polymer (TP) conveniently has a glass transition temperature of at least 65° C., even at least 75° C., preferably at least 80° C. The glass transition temperature may be greater than 80° C., even greater than 85° C. The glass transition temperature may be as high as 180° C., generally up to 170° C., in some instances as high as 160° C. The glass transition temperature of thermoplastic polymer (TP) is conveniently from 65° C. to 180° C., even from 80 to 170° C., from 85° C. to 165° C., and even greater than 85° C. to 160° C.

Thermoplastic polymer (TP) conveniently has a melting temperature of at most 320° C., even at most 315° C., in some instances at most 310° C. The melting temperature is generally at least 200° C., generally at least 220° C. The melting temperature of the thermoplastic polymer is conveniently from 200° C. to 310° C., even from 220° C. to 305° C., in some instances from 220° C. to 280° C.

Thermoplastic polymer (TP) in Layer (BL) conveniently exhibits an elongation at break at −40° C. of at least 2.5%. The elongation at break at-40° C. may be at least 3.0%, preferably at least 3.5%. Tensile properties, including elongation at break, are measured according to ISO 527-2 using test pieces according to ISO 1BA at a testing speed of 5 mm/min.

The vessel of the invention can advantageously be used for the storage and transportation of hydrogen.

Thermoplastic polymer (TP) exhibits a hydrogen permeation coefficient at 85° C. of at most 500 Ncm³·mm/m²·d. bar, at most 480 Ncm³·mm/m²·d·bar, preferably at most 450 Ncm³·mm/m²·d·bar, more preferably at most 350 Ncm³·mm/m²·d·bar. The lower the permeability coefficient the better are the barrier properties of the vessel. Hence the hydrogen permeation coefficient at 85° C. of the thermoplastic polymer may be as low as zero, typically as low as 1 Ncm³ mm/m²·d·bar, even as low as 10 Ncm³·mm/m²·d·bar.

The hydrogen permeation coefficient is determined by measuring the permeation of hydrogen at a pressure of 1 MPa at 85° C. through molded plaques of thermoplastic polymer (TP) which were annealed at a temperature of 20° C. above their glass transition temperature for 2 hours. The detailed method for the determination is described in the experimental section of the present specification.

Thermoplastic polymer (TP) may be selected from the group consisting of poly(arylene sulfide) polymers and semi-aromatic polyamides.

Thermoplastic polymer (TP) may be selected from poly(arylene sulfide) polymers. The poly(arylene sulfide) polymer typically contains at least 50.0 mol % of a recurring unit (RPAS) having at least one aromatic ring bonded to a sulfur atom. In some embodiment, the amount of recurring unit (RPAS) is at least 60.0 mol %, at least 70.0 mol %, at least 80.0 mol %, at least 90.0 mol %, at least 95.0 mol %, at least 97.0 mol %, at least 98.0 mol %, at least 99.0 mol % or at least 99.9 mol %. As used herein, mol % is relative to the total number of recurring units in the poly(arylene sulfide) polymer, unless explicitly noted otherwise.

Recurring unit (R_{PAS}) is represented by a formula selected from the following group of formulae:

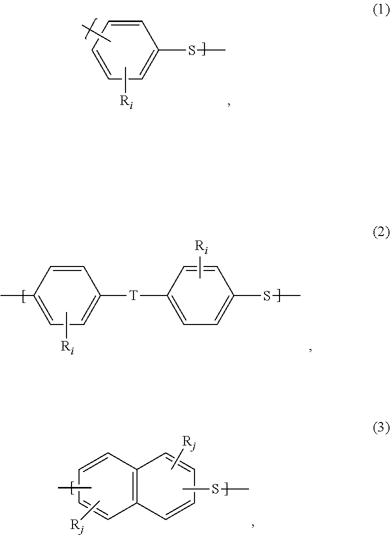

in which:
R is, at each instance, independently selected from the group consisting of a C₁-C₁₂ alkyl group, a C₇-C₂₄ alkylaryl group, a C₇-C₂₄ aralkyl group, a C₆-C₂₄ arylene group, and a C₆-C₁₈ aryloxy group;
T is selected from the group consisting of a bond, —CO—, —SO₂—, —O—, —C(CH₃)₂, phenyl and —CH₂—;
i is, at each instance, independently 0 or an integer from 1 to 4; and
j, is, at each instance, independently 0 or an integer from 1 to 3.

For the sake of clarity, when i or j is zero, the corresponding aromatic rings are unsubstituted.

Preferably, the poly(arylene sulfide) polymer has a melt flow rate of at most 700 g/10 min, more preferably of at most 500 g/10 min. Preferably, the poly(arylene sulfide) has a melt flow rate of at least 1 g/10 min, more preferably of at least 5 g/10 min. In the present specification, the melt flow rate of any poly(arylene sulfide) polymer refers to the value measured in an extrusion plastomer at 315.6° C. using a weight of 5 kg and a 0.21 cm×0.80 cm die after a 5 minute equilibration period, according to ASTM D1238, procedure B.

According to an embodiment of the present invention, the poly(arylene sulfide) polymer is poly (phenylene sulfide) (hereinafter referred to as “PPS”). The expression “poly (phenylene sulfide)” or PPS, is used to refer to a poly(arylene sulfide) polymer where the recurring unit (R_{PAS}) is represented by formula (1). More preferably, recurring unit (R_{PAS}) is represented by formula (4):

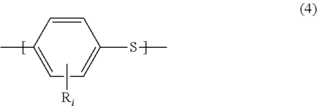

Most preferably in PPS, the recurring unit (R_{PAS}) is represented by formula (4) in which i=0.

The PPS may be acid washed or not acid washed. In some embodiments, the PPS is acetic acid washed PPS.

In a preferred embodiment, the PPS polymer is such that at least 90.0 mol % of the recurring units are recurring units of formula (4) in which i=0. The PPS polymer may consist essentially of recurring units of formula (4) in which i=0.

The melt flow rate (at 316° C. and 5 kg) of the PPS is typically from 5 to 200 g/10 min, for example from 7 to 180 g/10 min.

Suitable PPS is commercially available under the trade name Ryton® PPS from Solvay Specialty Polymers USA, LLC.

Thermoplastic polymer (TP) may alternatively be selected from the group consisting of the semi-aromatic polyamides. The expression “semi-aromatic polyamide” refers to a polyamide comprising recurring units deriving from at least one aromatic monomer and at least one aliphatic monomer. The aromatic monomer may be a diamine, a diacid or an aminoacid.

In an embodiment, the semi-aromatic polyamide may comprise recurring units deriving from an aromatic diamine.

The semi-aromatic polyamide may comprise at least 50 mol %, typically at least 70 mol % of recurring units deriving from the aromatic diamine with respect to the total amount of diamine units in the polyamide.

Preferably, the semi-aromatic polyamide comprises recurring units deriving from an aromatic diamine having 6 to 18 carbon atoms.

Examples of suitable C6-C18 aromatic diamines include, but are not limited to, m-phenylene diamine (MPD), p-phenylene diamine (PPD), 3,4′-diaminodiphenyl ether (3,4′ ODA), 4,4′-diaminodiphenyl ether (4,4′-ODA), p-xylylene diamine (PXD) and m-xylylenediamine (MXD).

Notable non-limiting examples of suitable polyamides comprising aromatic diamines are for instance polyamides comprising recurring units of formula MXDZ in which Z represents units deriving from a linear or branched, aliphatic or cyclo-aliphatic diacid having z carbon atoms, wherein z is an integer equal to or greater than 6 and MXD is m-xylylenediamine. Z is preferably selected from the aliphatic diacids having 6 to 16 carbon atoms. Notable non-limiting examples are adipic acid, sebacic acid or dodecanedioic acid. More preferably, Z is adipic acid.

In some embodiments, the semi-aromatic polyamide may additionally comprise recurring units of formula PXDZ wherein PXD represents units deriving from p-xylylene diamine and Z is as defined above.

In certain embodiments, the semi-aromatic polyamide is a polyamide of formula A/MXDZ in which A is a recurring unit derived from at least one of the following: an amino acid, that is a molecule containing a primary carboxylic acid and a primary amine, a lactam or a unit with the formula (Ca diamine). (Cb diacid), where “a” represents the number of carbon atoms of the diamine and “b” represents the number of carbon atoms of the diacid, and wherein “a” and “b” independently of each other are integers between 4 and 36, advantageously between 6 and 18. The component (Ca diamine) is preferably selected from the group consisting of the linear or branched aliphatic diamines, the cycloaliphatic diamines and the alkylaromatic diamines. Examples are, for instance, hexamethylenediamine, decanediamine, dodecanediamine and MXD.

The component (Cb diacid) is preferably selected from the group consisting of the linear or branched aliphatic diacids, the cycloaliphatic diacids and the aromatic diacids. Examples are for instance, adipic acid, sebacic acid or dodecanedioic acid or 3-(aminomethyl)benzoic acid (3-AMBa).

In an advantageous embodiment, the units A or Z can be derived from renewable materials. Non limiting examples of suitable polyamides of this type are: PA MXD6, PA MXD10.

In another embodiment, the semi-aromatic polyamide comprises recurring units deriving from an aromatic diacid.

In a preferred embodiment, the semi-aromatic polyamide comprises recurring units of formula XT, in which X represents units deriving from a linear or branched, aliphatic or cyclo-aliphatic diamine having x carbon atoms, wherein x is an integer equal to or greater than 6 and T represents units deriving from terephthalic acid. In formula XT, X may conveniently represent units deriving from a linear or branched, aliphatic or cyclo-aliphatic diamine having x carbon atoms, wherein x is selected from 6, 7, 8, 10, 11, 12, 13, 14, 15, 16.

The semi-aromatic polyamide comprises at least 50 mol %, typically at least 70 mol % of recurring units of formula XT, even at least 90 mol % of recurring units of formula XT.

The semi-aromatic polyamide may comprise more than one recurring unit of formula XT, wherein each unit X derives from a different diamine as defined above. Alternatively the semi-aromatic polyamide may comprise, in addition to recurring units of formula XT, recurring units of formula X′T, in which X′ represents units deriving from a linear or branched, aliphatic or cyclo-aliphatic diamine having x′ carbon atoms, wherein x′ is an integer lower than 6.

In some embodiments, the semi-aromatic polyamide may additionally comprise recurring units of formula XI, wherein I represents units deriving from isophthalic acid and X is as defined above.

The units X in formula XT, or units XI when present, derive from a linear or branched, aliphatic or cyclo-aliphatic diamine having x carbon atoms, x being equal to or greater than 6 and up to 36, advantageously between 8 and 18, even equal to 8, 10, 11, 12, 14, 16. Units X preferably derive from aliphatic diamines selected from the group consisting of 1,8-octanediamine, 2-methyl-1,8-octanediamine (Me8), 1,10-decanediamine, 1, 12-dodecanediamine, 2,2,4-trimethyl-1,6-hexanediamine, 2,4,4-trimethyl-1,6-hexanediamine, 5-methyl-1,9-nonanediamine, 1,3-bis(aminomethyl)cyclohexane, 1,4-bis(aminomethyl)cyclohexane, isophoronediamine and mixtures thereof. In a preferred embodiment of the invention, unit X derives from the group of aliphatic diamines consisting of 1,8-octanediamine, 1,10-decanediamine, 1,12-dodecanediamine and mixtures thereof. More preferably unit X derives from the group of aliphatic diamines consisting of 1,10-decanediamine, 1,12-dodecanediamine and mixtures thereof.

In certain embodiments, the aliphatic diamine can be derived from renewable materials. Notable non-limiting examples of such diamines are for instance 1,10-decanediamine and 1,12-dodecanediamine, which can be derived from castor oil.

Notable non-limiting examples of suitable polyamides comprising only recurring units of formula XT or XT/X′T are PA 6T, PA 8T, PA 10T, PA 11T, PA 12T, PA 6T/9T, PA 9T/10T, PA 9T/11T, PA 9T/12T, PA 6T/10T, PA 6T/11T, PA 6T/12T, PA 10T/11T, PA 10T/12T, PA 11T/12T.

In certain embodiments, the semi-aromatic polyamide is a co-polyamide of formula Y/XT, wherein XT is as defined above and Y is a recurring unit derived from at least one of the following: an amino acid, that is a molecule containing a primary carboxylic acid and a primary amine, a lactam or a unit with the formula (Cn diamine) (Cm diacid), where “n” represents the number of carbon atoms of the diamine and “m” represents the number of carbon atoms of the diacid, and wherein “n” and “m” independently of each other are integers between 4 and 36, advantageously between 6 and 18.

The component (Cn diamine) is preferably selected from the group consisting of the linear or branched aliphatic diamines, the cycloaliphatic diamines and the alkylaromatic diamines. The component (Cm diacid) is preferably selected from the group consisting of the linear or branched aliphatic diacids, the cycloaliphatic diacids and the aromatic diacids.

In an advantageous embodiment, the units Y in formula Y/XT can be derived from renewable materials. Notable non-limiting examples of diacids or aminoacids derived from renewable sources are for instance sebacic acid or 3-(aminomethyl)benzoic acid (3-AMBa), which can be derived from furfural.

Notable non-limiting examples of suitable co-polyamides comprising recurring units of formula XT as defined above are for instance polyamides selected from the group consisting of: PA 6T/61, PA 6T/66, PA 6T/6I/66, PA 10/6T, PA 10/9T, PA 10/10T, PA 10/11T, PA 10/12T, PA 11/6T, PA 11/9T, PA 11/10T, PA 11/11T, PA 11/12T, PA 12/6T, PA 12/9T, PA 12/10T, PA 12/11T, PA 12/12T, PA 610/6T, PA 612/6T, PA 910/6T, PA 912/6T, PA 1010/6T, PA 1012/6T, PA 610/9T, PA 612/9T, PA 910/9T, PA 912/9T, PA 1010/9T, PA 1012/9T, PA 610/10T, PA 612/10T, PA 910/10T, PA 912/10T, PA 1010/10T, PA 1012/10T, PA 610/12T, PA 612/12T, PA 910/12T, PA 912/12T, PA 1010/12T, PA 11/6T/9T, PA 11/6T/10T, PA 11/6T/11T, PA 11/6T/12T, PA 11/9T/10T, PA 11/9T/11T, PA 11/9T/12T, PA 11/10T/11T, PA 11/10T/12T, PA 11/11T/12T, PA 12/6T/10T, PA 12/6T/11T, PA 12/6T/12T, 12/9.T/10.T, PA 12/9T/11T, PA 12/9T/12T, PA 12/10T/11T, PA 12/10T/12T, PA 12/11T/12T, PA MXDT/10T, PA MPMDT/10T, PA BACT/10T, PA BACT/6T, PA BACT/10T/6T, PA 11/BACT, PA 11/BACT/10T.

The semi-aromatic polyamide may conveniently be selected from the group consisting of PA 6T/66, PA 6T/6I/66, PA 9T/10T.

Layer (BL) has a thickness which provides the required value of gas permeation required for the application. Layer (BL) typically has a thickness of at least 100 microns, generally at least 250 microns. Layer (BL) may have a thickness of up to 10.0 mm, even 8.5 mm, 7.5 mm. Layer (BL) may have a thickness of 100 microns to 10.0 mm, generally from 250 microns to 10.0 mm, even from 300 microns to 8.5 mm, still from 500 microns to 6.0 mm.

Layer (BL) may comprise one or more than one thermoplastic polymer (TP) and, optionally, one or more additives commonly employed in the formulation of thermoplastic polymers.

Non limiting examples of suitable additives are antioxidants (e.g. ultraviolet light stabilizers and heat stabilizers), chain extender, processing aids, nucleating agents, lubricants, flame retardants, smoke-suppressing agents, anti-static agents, anti-blocking agents, colorants, and pigments.

The total amount of additives may be 20.0 wt % or less, even 10.0 wt % or less with respect to the total weight of Layer (BL). When present the amount of the one or more additives is at least 0.1 wt %, even at least 0.5 wt %, relative to the total weight of the thermoplastic polymer (TP).

Layer (BL) may comprise one or more thermoplastic polymer (TP) and an impact modifier.

Suitable impact modifiers are for instance functionalized polyolefins with a glass transition temperature lower than 25° C.

The polymer backbone of the impact modifier can be selected from elastomeric backbones comprising polyethylenes and copolymers thereof, e.g. ethylene-butene; ethylene-octene; polypropylenes and copolymers thereof; polybutenes; polyisoprenes; ethylene-propylene-rubbers (EPR); ethylene-propylene-diene monomer rubbers (EPDM); ethylene-acrylate rubbers; butadiene-acrylonitrile rubbers, ethylene-acrylic acid (EAA), ethylene-vinylacetate (EVA); acrylonitrile-butadiene-styrene rubbers (ABS), block copolymers styrene ethylene butadiene styrene (SEBS); block copolymers styrene butadiene styrene (SBS); core shell elastomers of methacrylate-butadiene-styrene (MBS) type, or mixture of one or more of the above.

When the impact modifier is functionalized, the functionalization of the backbone can result from the copolymerization of monomers which include the functionalization or from the grafting of the polymer backbone with a further component.

Specific examples of functionalized impact modifiers are notably terpolymers of ethylene, acrylic ester and glycidyl methacrylate, copolymers of ethylene and butyl ester acrylate; copolymers of ethylene, butyl ester acrylate and glycidyl methacrylate; ethylene-maleic anhydride copolymers; EPR grafted with maleic anhydride; styrene copolymers grafted with maleic anhydride; SEBS copolymers grafted with maleic anhydride; styrene-acrylonitrile copolymers grafted with maleic anhydride; ABS copolymers grafted with maleic anhydride.

Functionalized polyolefin impact modifiers are available from commercial sources, including maleated polypropylenes and ethylene-propylene copolymers available as Exxelor® PO and maleic anhydride-functionalized ethylene-propylene copolymer rubber comprising about 0.6 weight percent pendant succinic anhydride groups, such as Exxelor® VA 1801 from the ExxonMobil Chemical Company; acrylate-modified polyethylenes available as Surlyn®, such as Surlyn® 9920, acrylic or methacrylic acid-modified polyethylene from Dow Inc.; maleic anhydride-modified SEBS block copolymer, such as Kraton® FG1901X, a SEBS that has been grafted with about 2 wt % maleic anhydride, available from Kraton Polymers; maleic anhydride-functionalized EPDM terpolymer rubber, such as Royaltuf® 498, a 1% maleic anhydride functionalized EPDM, available from the SI Group.

Other desirable functionalized impact modifiers include, but are not limited to, ethylene-higher alpha-olefin polymers and ethylene-higher alpha-olefin-diene polymers grafted or copolymerized with reactive carboxylic acids or their derivatives such as, for example, acrylic acid, methacrylic acid, maleic anhydride or their esters. Suitable higher alpha-olefins include, but are not limited to, C3 to C8 alpha-olefins such as, for example, propylene, 1-butene, 1-hexene and styrene.

Among reactive impact modifiers mention may be made of a random terpolymer of ethylene, acrylic ester and glycidyl methacrylate which is commercially available from Arkema (Bristol, PA, USA) under the trade name Lotader® AX8900. Another example of the aforementioned reactive impact modifier is commercially available from Dow Inc. (Midland, MI, USA) under the trade name Paraloid™ EXL 2314, which is a core-shell type acrylate based impact modifier comprised of a core primarily comprised of cross-linked poly (n-butyl acrylate) rubber and having a shell phase comprised primarily of a poly(methyl methacrylate)-poly (glycidyl methacrylate) copolymer.

In said second embodiment, Layer (BL) comprises from 1.0 wt % to 25.0 wt % of the at least one impact modifier with respect to the total weight of Layer (BL). The impact modifier can be at least 2.0 wt % or at least 3.0 wt %, even at least 5.0 wt % of the total weight of Layer (BL). The impact modifier typically is not more than 20.0 wt %, not more than 15.0 wt %, not more than 12.0 wt %, even not more than 10.0 wt %. Suitable ranges may be for instance from 1.0 to 15.0 wt %, even from 1.0 to 12.0 wt %, or even 2.0 to 10.0 wt %.

In the second embodiment Layer (BL) may additionally comprise additives as detailed above. The total amount of additives may be 20.0 wt % or less, even 10.0 wt % or less with respect to the total weight of Layer (BL) and/or at least 0.1 wt %, even at least 0.5 wt % with respect to the total weight of Layer (BL).

When more than one Layer (BL) is present in the vessel of the invention, each Layer (BL) may comprise the same or a different thermoplastic polymer (TP).

### Layer (CL)

The vessel of the invention comprises at least one barrier layer, [Layer (BL)] as above defined, and it may comprise at least one composite layer, [Layer (CL)], in contact with the at least one barrier layer, wherein Layer (CL) comprises continuous reinforcing fibers and a polymer matrix.

Layer (BL) represents the internal layer of the vessel, or liner, while Layer (CL) represents the external layer of the vessel.

The polymer matrix in Layer (CL) may be either a thermoplastic or a thermoset polymer.

Among suitable thermoplastic polymers suitable as polymer matrix in Layer (CL) mention may be made of: polyamides, in particular comprising an aromatic and/or cycloaliphatic structure, polyesters, such as poly (butylene terephthalate), poly(aryl ether ketone) polymers as defined above, in particular poly (ether ether ketone) (PEEK), poly (ether ketone ketone ketone) (PEEKK), poly (ether ketone ether ketone ketones) (PEKEKK), polyimides, in particular polyetherimides (PEI) or polyamide-imides, polysulfones, in particular polyarylsulfones such as polyphenylsulfones (PPSU), polyethersulfones (PES), poly(aryl sulfide) polymers; in particular PPS as defined above.

Preferred thermoplastic polymers may be selected from the group consisting of polyamides, poly(aryl ether ketone) polymers and poly(aryl sulfide) polymers.

Among suitable thermoset materials for the polymer matrix in Layer (CL) mention may be made of epoxy-resins.

Layer (CL) comprises continuous reinforcing fibers. As used herein, the expression “continuous reinforcing fiber” refers to a fiber having a length, in the longest dimension, of at least 5 mm.

In some embodiments, the continuous reinforcing fiber has a length, in the longest dimension, of at least 1 cm, at least 25 cm or at least 50 cm. The length of the continuous reinforcing fiber is dependent on the shape and size of the finished part.

The continuous reinforcing fiber is selected from the group consisting of, glass fiber, carbon fibers, aluminum fiber, metallic fibers, ceramic fiber, titanium fiber, magnesium fiber, boron carbide fibers, rock wool fiber, steel fiber, aramid fiber and natural fiber (e.g. cotton, linen and wood). Preferably, the continuous reinforcing fiber is selected from the group consisting of glass fiber, carbon fiber, aramid fiber, and ceramic fiber. Advantageously, the continuous reinforcing fiber is carbon fiber.

In some embodiments, Layer (CL) may include one or more additional continuous reinforcing fibers, each distinct in compositions and as described above.

Overall, the continuous reinforcing fibers constitute at least 5.0% of the total volume of Layer (CL). Typically the continuous reinforcing fibers are at least 10.0%, at least 15.0%, even at least 20.0% of the total volume of Layer (CL). The continuous reinforcing fibers are no more than 80.0%, no more than 75.0%, even no more than 70.0% of the total volume of Layer (CL). The continuous reinforcing fibers may conveniently represent from 20.0% to 75.0%, from 25.0% to 70.0%, from 25.0% to 65.0% and even from 30.0% to 60.0% of the total volume of Layer (CL). The polymer matrix represents the remainder of the volume of Layer (CL).

The continuous reinforcing fibers in Layer (CL) are generally aligned along a single direction. Generally aligned fibers are oriented such that at least 70%, at least 80%, at least 90% or at least 95% of the fibers have a direction that is within 30 degrees, within 25 degrees, within 20 degrees, within 15 degrees, or within 10 degrees along the direction of the other fibers.

In certain embodiments the continuous reinforcing fibers in Layer (CL) may be arranged at an angle the ones with respect to the others. The continuous reinforcing fibers might be arranged as a woven fabric or a layered fabric or any combination of one or more.

Layer (CL) can be fabricated by methods well known in the art. In general, the method of fabrication includes a step of impregnation of the continuous reinforcing fibers with a polymer matrix or a precursor of the polymer matrix when the polymer is a thermosetting polymer, and subsequent cooling or drying to form a Layer (CL).

When more than one Layer (CL) is present, each Layer (CL) may be the same or different.

Layer (CL) has a thickness which is usually between 100 microns and 500 microns. The thickness is adapted to provide the required structural resistance to the vessel.

### The Vessel

The term “vessel” is used herein to refer to a hollow container. The vessel of the invention is in particular a hollow container for containing a gas, preferably a pressurized gas.

Layer (BL) represents the sole or the internal layer of the vessel which is in contact with the gas to be transported or stored, hereinafter referred to as “liner”. Layer (CL), when present, represents the external layer of the vessel.

The vessel may comprise one Layer (BL) and one or more Layers (CL). In one aspect of this embodiment, when more Layers (CL) are present they have the same composition. Layers (CL) may be 2, 3, 5, 10, 50 and even up to 100 or more, such as 200 or 300.

The vessel is preferably a pressure vessel, that is a vessel suitable for the storage and transport of a gas under pressure.

The vessel, or preferably the pressure vessel, comprises a hollow body and at least one boss. A boss is known by a person skilled in the art and it refers to the opening in which a closure is attached which allows flow of gas or fluid in and out the vessel. A boss is usually made of metal.

The hollow body may have any shape suitable for the storage of a gas, in particular of a gas under pressure.

In certain conventional embodiments, the vessel has a cylindrical shape and a boss is placed at the end. Often, a vessel has two bosses at each end of the cylindrical shape.

The shape of the hollow body is determined by the desired use. It is usually but not exclusively cylindrical; it typically has a diameter of between 10.0 cm and 1.00 m.

The length of a hollow body also depends on the end use and may for example be between 50.0 cm and up to lengths as large as 10.0 m. These higher lengths are usually employed for gas transport. As an example, for vessels in trucks the length is usually between 1.0 m and 3.0 m.

The vessel of the invention may have an internal volume between 3.5 dm³ and 5.0 m³, even from 5.0 dm³ to 1.0 m³. The internal volume of the vessel may be at least 10.0 dm³, even at least 15.0 dm³. The internal volume may be up to 1.0 m³, even up to 0.5 m³.

The vessel comprises a hollow body which may consist solely of one or more Layer (BL). Alternatively the vessel may comprise, from the inside to the outside of the vessel: at least one Layer (BL), or liner, as defined above, and at least one structural composite layer, which is Layer (CL) as defined above, in contact with the at least one Layer (BL). Layer (BL) is in contact with the gas contained in the vessel.

The liner intends to provide a barrier between the fluid or gas and the Layer (CL), preventing leaks. In general, Layer (CL) is provided around the liner to provide mechanical properties, such as burst pressure resistance.

The vessel may be prepared according to any method known in the art.

For instance, the liner may be prepared by blow molding, tube extrusion, injection molding and welding and/or roto-molding. Layer (CL), when present, may then be applied on the outer surface of the liner by winding a tape or a towpreg comprising continuous reinforcing fibers and a polymer matrix around the hollow body made of the liner.

Other manufacturing processes as known in the art for the manufacture of pressure vessels can be used for making the inventive vessel.

The vessel of the invention is characterized by a good hydrogen barrier and mechanical properties.

The vessel according to the invention exhibits a nominal pressure of at least 2.5 MPa, typically at least 20.0 MPa, even at least 30.0 MPa. The nominal pressure may be up to 70.0 MPa, 100 MPa, even 150.00 MPa and more. Advantageously, the vessel of the invention has a nominal pressure of 20.0 to 70.0 MPa.

A burst pressure of at least 157.5 MPa may be reached for the storage of hydrogen gas with a vessel according to the invention. Vessels for the storage of compressed hydrogen typically require nominal pressures of 35.0 MPa or 70.0 MPa. Burst pressures, measured according to ECE R134, are typically up to 78.8 MPa and 157.5 MPa, respectively.

A further object of the invention is a compressed gas in a vessel comprising the multilayer structure of the first object, wherein Layer (BL) is in contact with the compressed gas. The gas is advantageously selected from the group consisting of hydrogen, oxygen, nitrogen, argon, helium, methane, propane, compressed natural gas, CO₂ and ammonia.

The gas is typically at a pressure of at least 5.0 MPa, preferably at least 10.0 MPa. Depending on the gas, the pressure may be up to 150.0 MPa.

A third object of the invention is a hence compressed gas contained in the vessel wherein Layer (BL) is in contact with the compressed gas. The gas is advantageously selected from the group consisting of hydrogen, oxygen, nitrogen, argon, helium, methane, propane, compressed natural gas, CO₂ and ammonia.

The gas is typically at a pressure of at least 5.0 MPa, preferably at least 10.0 MPa. Depending on the gas, the pressure may be up to 150.0 MPa.

A further object of the invention is a vehicle comprising the vessel or the compressed gas contained in the vessel.

The vehicle may be a car, a truck, a train, a ship, an urban mobility vehicle, an airplane, a helicopter or any other vehicle that could be powered using the conversion of a gas into energy by any means.

The embodiments above are intended to be illustrative and not limiting. Additional embodiments are within the inventive concepts. In addition, although the present invention is described with reference to particular embodiments, those skilled in the art will recognize that changes can be made in form and detail without departing from the spirit and scope of the invention.

### EXAMPLES

### Materials

PA1: Amodel® 1004 a PA 6T/6I/66 copolymer commercially available from Solvay Specialty Polymer USA, LLC
PA2: Amodel® ET 1000 HS NT an impact modified PA 6T/6I/66 copolymer, commercially available from Solvay Specialty Polymer USA, LLC
PA12 is Grilamid® L25NZ an impact modified PA12 commercially available from EMS Chemie
PA6 is NYLON™ 1218IU from UBE Industries

### Tensile Testing

Tensile properties were measured according to ISO 527-2 using samples meeting the requirements of ISO 1BA at a test speed of 5 mm/min and at the indicated temperature. The samples were annealed at a temperature of 20° C. above their glass transition temperatures for a period of 2 h to ensure full crystallinity prior to tensile testing.

### H₂ Permeation Coefficient Determination

Samples for hydrogen permeation testing were prepared as follows. Polymers were dried overnight at 107° C. in a desiccant drying oven with a-40° C. dew point to ensure material was dry prior to injection molding into plates. Material was injection molded into 10 cm×10 cm×0.32 cm plates using a 250 ton Sumitomo SE 250 EV-A HD all electric injection molding machine, following the polymer suppliers recommended injection molding processing guidelines. The molding machine was fitted with a 45 mm screw size with a maximum screw speed of 250 rpm with a maximum shot capacity of 0.34 dm3. The machine had a maximum shot size of 21 cm and the maximum injection pressure was 215 MPa. The plates were annealed at a temperature of 20° C. above their glass transition temperatures for a period of 2 h to ensure full crystallinity prior to hydrogen permeation testing.

Samples were mounted in a sealed chamber and a check was made to ensure that the chamber was leak tight by applying hydrogen at 1 MPa on the feed side. Subsequently the chamber was conditioned at the temperature of testing. On the feed side H₂ was fed at 1 MPa. On the permeate side, synthetic air was fed at a controlled throughput and H₂ was measured using a calibrated Inficon Sentrac H₂ Leak Detector, until a stable value for H₂ was obtained to assure a stationary regime.

The permeation coefficient was calculated taking into account the thickness of the sample, the exposed surface, the flow rate of the carrier gas and the pressure. The results are shown in Table 1.

TABLE 1

| | | | Strain @ Break | H₂ Permeation |
|---|---|---|---|---|
| | Thermal properties | | @−40° C. | Coefficient @ 85° C. |
| | Tm (° C.) | Tg (° C.) | % | (Ncm³ · mm/m² · d · bar) |
| PA1 | 310 | 125 | 7 | 86 |
| PA2 | 310 | 125 | 8 | 203 |
| Ref. PA12 | 178 | 49 | 17 | 2620 |
| Ref. PA6 | 213 | 54 | — | 400 |

The combination of the properties above allows the design of thinner liners with excellent hydrogen barrier properties without compromising the mechanical properties of the vessel.

1. A vessel comprising at least one barrier layer, layer (BL), which comprises at least one thermoplastic polymer, thermoplastic polymer (TP), which is characterized by:
a glass transition temperature of at least 65° C.;
a melting temperature of at most 320° C.;
an elongation at break at −40° C. of at least 2.5% when measured according to ISO 527-2 using test pieces according to ISO 1BA at a testing speed of 5 mm/min; and
a hydrogen permeation coefficient at 85° C. of at most 500 Ncm³·mm/m²·d·bar.

2. The vessel of claim 1, wherein the thermoplastic polymer (TP) has a glass transition temperature greater than 80° C. and not exceeding 180° C.

3. The vessel of claim 1, wherein the thermoplastic polymer (TP) has at least one of the following: a melting temperature from 200° C. to 315° C.; an elongation at break at −40° C. of at least 3.0%; a hydrogen permeation coefficient at 85° C. from 1 to 400 Ncm³·mm/m²·d·bar.

4. The vessel of claim 1, wherein the thermoplastic polymer (TP) is selected from the group consisting of poly(arylene sulfide) polymers and semi-aromatic polyamides.

5. The vessel of claim 1, wherein the thermoplastic polymer (TP) is a semi-aromatic polyamide selected from the group consisting of the semi-aromatic polyamides comprising recurring units of formula XT, wherein T is terephthalic acid and X represents units deriving from a linear or branched, aliphatic or cyclo-aliphatic diamine having x carbon atoms, wherein x is selected from 6, 7, 8, 10, 11, 12, 13, 14, 15, 16.

6. The vessel of claim 1, wherein the thermoplastic polymer (TP) is selected from PA 6T/66 and PA 6T/6I/66.

7. The vessel of claim 1, wherein the thermoplastic polymer (TP) is poly (phenylene sulfide).

8. The vessel of claim 1, wherein the Layer (BL) comprises thermoplastic polymer (TP) and from 1 wt % to 25 wt % of the at least one impact modifier with respect to the total weight of the Layer (BL).

9. The vessel of claim 1, comprising at least one layer (BL) and at least one composite layer, layer (CL), in contact with the at least one layer (BL) wherein Layer (CL) comprises continuous reinforcing fibers and a thermoplastic or thermoset polymer matrix.

10. The vessel of claim 9, wherein the continuous reinforcing fibers are selected from the group consisting of glass fiber, carbon fiber, aramid fiber, and ceramic fiber.

11. The vessel of claim 1, wherein Layer (BL) represents the internal layer of the vessel and Layer (CL) represents the external layer of the vessel.

12. The vessel of claim 1, wherein the vessel is in the shape of a hollow body which has one or more of the following:
a diameter of 10.0 cm to 1.0 m;
a length of 50.0 cm to 10.0 m; and
an internal volume of 3.5 dm³ to 5.0 m³.

13. A compressed gas, wherein the compressed gas is contained in the vessel of claim 1, and wherein the compressed gas is in contact with Layer (BL).

14. The compressed gas of claim 13, wherein the compressed gas is selected from the group consisting of hydrogen, oxygen, nitrogen, argon, helium, methane, propane, compressed natural gas, CO₂, ammonia.

15. A vehicle comprising the vessel of claim 1.

16. A method, comprising storing or transporting a compressed gas with the vessel of claim 1 to contain the compressed gas.

17. The vessel of claim 10, wherein the continuous reinforcing fibers in an amount of 20% to 75% with respect to the total volume of Layer (CL).

18. A vehicle comprising the compressed gas of claim 13.
